(19) United States
(12) Patent Application Publication
(10) Pub. No.: US 2020/0384952 A1
(43) Pub. Date: Dec. 10, 2020

(54) Control System For A Motor Vehicle And Method For Controlling At Least One Vehicle Function Of A Motor Vehicle

(71) Applicant: U-Shin Deutschland Zugangssysteme GmbH, Erdweg (DE)

(72) Inventor: Marc-Tell Lammich, Erdweg (DE)

(21) Appl. No.: 16/892,451

(22) Filed: Jun. 4, 2020

(30) Foreign Application Priority Data
Jun. 4, 2019 (DE) 102019114912.6

(51) Int. Cl. B60R 25/24; B60R 25/01; G07C 9/00

(52) U.S. Cl. CPC B60R 25/245; B60R 25/01; G07C 9/00182; G07C 2009/00301; G07C 2009/00269; G07C 2009/00285; G07C 2009/00293; B60R 2325/205

(57) ABSTRACT

The disclosure relates to a control system for a motor vehicle. The control system includes at least a detection device which detects by wireless transmission at least one position of respective portable key elements relative to the motor vehicle and which determines by wireless transmission for which of the respective portable key elements the position has been detected. A control device controls respective vehicle functions in dependence on the respective detected position of a first key element and/or a second key element, and the control device controls respective vehicle functions for substantially equal positions of the first and second key elements with a first parameter set in case of the first key element and to control respective vehicle functions with a second parameter set in case of the second key element. The first parameter set and the second parameter set differ from each other.

### TECHNICAL FIELD

The present invention relates to a control system for a motor vehicle and a method for controlling at least one vehicle function of a motor vehicle.

### STATE OF THE ART

A frequently automatically controlled vehicle function in modern motor vehicles concerns, for example, the opening and closing of the respective vehicle doors. Such automatic access control of motor vehicles allows for their convenient use. For example, an approach of a key element to a motor vehicle, wherein, for example, a user of the motor vehicle carries the key element with him, can be detected by wireless transmission and, depending on this, a vehicle door can be opened. The user or this person no longer has to operate the vehicle door manually, for example by pulling a door handle and/or pressing a button on a key element configured as a remote control. In addition, the vehicle door can be fully opened before the person reaches the vehicle or the vehicle door. This makes it possible to comfortably get into the vehicle without delay.

A disadvantage of an automatic access control system, however, may be that the automatic system can cause an adjustment of the respective access elements of a motor vehicle, which does not or only partially correspond to respective current user wishes. This may possibly lead to inconvenient situations.

Automatic access control to a motor vehicle by wireless transmission is, for example, known from the US 2018/0265039 A1. Therein, a vehicle's air conditioning system is also set according to user preferences and/or weather data.

### DESCRIPTION OF THE INVENTION

The object of the present invention is to enable a particularly convenient control of vehicle functions of a motor vehicle.

This object is solved by the subject-matter of the independent patent claims. Advantageous embodiments with expedient further developments of the invention are indicated in the respective dependent claims.

A first aspect of the invention concerns a control system for a motor vehicle. The control system may comprise at least a first portable key element and a second portable key element. The key element may be, for example, a wireless transmission key, a chip card, an element with an RFID chip, a remote control and/or a smart phone. Two key elements may allow independent access to the vehicle by two different users, wherein the different users may have different preferences regarding respective automatically executed vehicle functions and respective vehicle settings or their respective setting and/or control.

The control system may also have more than two key elements. Some of these key elements can be treated in the same way by the control system and accordingly result in the same control of the vehicle functions. Thus, a third key element can, for example, be configured as a replacement key element for the first or second key element. However, some or all of the additional key elements can also be treated differently by the control system and accordingly cause a different control of the vehicle functions than the second and third key elements. A third key element can therefore also be provided, which enables independent access to the motor vehicle by a further third user in addition to a first and second user. The type of control or consideration of the respective different key elements is explained in the following using the two key elements as examples, whereby these explanations also apply to other distinguishable key elements.

Furthermore, the control system may include a detection device which is configured to detect at least one position of the respective portable key elements relative to the motor vehicle by wireless transmission. Such a detection can be carried out, for example, by triangulation between different transmitters and/or receivers on the motor vehicle, which are configured, for example, to communicate with the respective key elements by wireless transmission. In addition, the detection device can also be configured to determine by wireless transmission for which of the respective portable key elements the position has been detected. This detection can be simultaneous or independent of the position detection. For example, each key element may have an identifier which is transmitted during communication with the detection device and allows correlation to a particular one of the respective key elements. Determining from which of the key elements the position was detected can also comprise an assignment of the respective positions to the respective key elements if for more than one key element the position was detected simultaneously.

Furthermore, the control system may include a control device configured to control respective vehicle functions depending on the respective detected position of the first key element and/or the second key element. The control device can, for example, control respective vehicle functions when only one of the two key elements is within range of the detection device or also when both key elements are within range. Preferably the control device is configured to control respective vehicle functions differently when only one of the two key elements is detected than when both key elements are detected.

In addition, the control device may be configured to control respective vehicle functions for substantially equal positions of the first and second key elements with a first parameter set in case of the first key element and to control respective vehicle functions with a second parameter set in case of the second key element, wherein the first parameter set and the second parameter set differ from each other. The parameter set can represent respective user preferences and/or access rights. This allows automatic control of vehicle functions according to user preferences for different users. In particular, there is a gain in convenience because the respective automatic vehicle function control can be configured to different users. Thus, a multi-user concept is realized, which can be especially convenient for each individual user.

For example, a first user may use a motor vehicle preferentially to transport freight and carry a first key element assigned to that user. For this user, the control system can be configured so that a tailgate is always opened automatically even when the driver approaches the driver's door. For example, a second user may use the same vehicle exclusively for driving and carry a second key element assigned to that second user. When approaching the driver's door of the motor vehicle, the control system opens only this door and optionally already automatically releases an ignition. A third user may, for example, be a minor and therefore not entitled to drive, but nevertheless carry a third key element assigned to him. Even if approaching the driver's door, the control system will then only open other access elements and the ignition will not be released. Here it is immediately apparent how, with the same detected position or a sequence of positions, the respective vehicle functions are controlled differently, resulting in increased convenience for the respective users. Thereby, the same motor vehicle can be used by several users together without necessitating any loss of comfort for the respective users. The control system also allows key elements for children, whereby dangerous functions such as driving, releasing the respective brakes, etc. can be deactivated. This enables a child to wait in a motor vehicle safely and protected from the weather for a driver, such as a parent.

Such a control system can be particularly advantageous for car sharing systems. Accordingly, the control system can be configured to control the respective vehicle functions of several vehicles. For this purpose, a corresponding control device can be provided for each motor vehicle or a central control device for all motor vehicles. Correspondingly, the same user preferences can be taken into account for different motor vehicles, even if there is a large number of users.

For example, the control system can allow different access rights for each key element, which are executed automatically. The first key element allows, for example, the use of all vehicle functions and is available in particular to the owner of the motor vehicle. The second key element, on the other hand, cannot, for example, allow the trunk to be opened, but can, for example, allow the engine to be started and the vehicle to be driven. This key element can be given to a parking assistant at a hotel, for example.

The respective access rights and thus configurations of corresponding devices can also be transferred electronically. For example, a digital key can be sent to a mobile phone, configuring it as the second key element. Preferably such a digital key is encrypted.

For example, controlling vehicle functions can only be enabling the use of a function. However, controlling may also be an automatic setting and/or execution of a vehicle function, such as starting the engine, opening and/or closing respective doors, setting and/or activating an air conditioning system and/or adjusting one or more vehicle seats. The control may also take into account the positional sequence of respective key elements, such as direction of movement, history and speed. Additionally or alternatively, a user or key element movement can also be predicted on the basis of the position detection and taken into account for the control. The position or control in dependence thereon may also include a direction of movement, zone, speed, etc., which are calculated by the control device based on one or more detected positions.

A position may also relate to a zone or area in the context of the detection and/or control system. For example, a position in front of a particular vehicle door may be considered to be essentially the same position, even if, for example, one of the two key elements is closer to the door than the other. For the position detection respective zones may be considered. For example, the area around the vehicle may be divided into a zone inside the vehicle and one or more zones outside the vehicle. Essentially the same position may in particular concern a control-relevant resolution. For example, if classified by zones, the essentially same position can only mean the same zone.

Preferably, the detection device is configured as part of the motor vehicle and comprises, for example, respective transmitters and/or receivers for detecting the position of respective key elements. The control device can be part of the motor vehicle, an external device, in particular a central server, and/or also part of the key elements. In particular, the control device can also be implemented on a smartphone and/or each key element and transmit respective control commands to the motor vehicle by wireless transmission. The respective key elements can be configured not to be part of the control system. In this case the control system may be configured to cooperate with the respective key elements.

In a further advantageous embodiment of the control system it is provided that respective vehicle functions are unlocking and/or opening respective access elements, such as a vehicle door, a vehicle window and/or a boot lid, activating and/or adjusting a ventilation system, in particular an air conditioning system, adjusting respective vehicle seats, activating the ignition and/or starting the engine, and/or authorizing the use of vehicle functions, such as a driving function by unlocking an immobilizer. Each of these vehicle functions can be automatically controlled differently for respective users when approaching the motor vehicle in order to achieve a particularly high level of user comfort, to increase safety for respective users and/or to make vehicle use by several persons particularly convenient for each user.

In a further advantageous embodiment of the control system, it is provided that the first parameter set comprises a first set of vehicle functions and the second parameter set comprises a second set of vehicle functions, the first set of vehicle functions and the second set of vehicle functions differing from each other by at least one of the respective vehicle functions of the motor vehicle. The first set may thus comprise different functions to be controlled than the second set. For example, starting the engine may only be authorized for one access element. This makes it easy to implement different access rights for different users or different key elements for automatic function control, such as access control to the motor vehicle.

The respective parameter sets can be stored in one or more databases, for example. The database may, for example, be part of the control device, making it securely available, and/or be stored on a server. Centralized storage enables online modification and thus centralized management, which is particularly advantageous for a car sharing concept. The parameter sets can be mirrored locally for offline availability, for example in case of connection availability. Local storage on the key elements is particularly suitable. For example, an assigned parameter set can be stored on each of the key elements, which can also be a local mirror or copy. Thus, the parameter sets are always available when they are needed and/or can be modified by the respective owners of the key elements even without a data connection to the vehicle and/or a central server.

In a further advantageous embodiment of the control system it is provided that the first parameter set comprises a first set of control commands for the respective vehicle functions and the second parameter set comprises a second set of control commands for the respective vehicle functions, wherein the first set of control commands and the second set of control commands differ from each other at least in the case of one control command. In particular, these can be different sets of control commands for the same vehicle functions or the same set of vehicle functions. In case of the first set of control commands, functions are controlled differently than in case of the second set of control commands, for example with a different setting value. In particular, the set of control commands can therefore have one or more setting parameters. Each control command can affect a setting to a specific value and/or state. For example, the same function can be set or controlled differently depending on user preference. For example, when approaching the vehicle, the air conditioning, respective seats and/or the radio set can be automatically adjusted according to user preferences.

The control system, especially the control device, can be configured to represent a hierarchy. The hierarchy can be predefined for the key elements and/or by the position of the respective key elements. For example, the control command set assigned to the first key element can take precedence over the second control command set as a matter of principle or only for certain vehicle functions. For example, the radio set, seats and/or air conditioning can always be set automatically according to the wishes of the vehicle owner, provided the owner also uses the vehicle. Other user preferences can then only be applied secondarily. A priority or hierarchy of commands depending on the detected positions makes it possible, for example, for the control command set of the user or key element approaching the driver's door, and therefore likely to be the driver, to be used with priority, especially for adjusting the driver's seat and/or air conditioning, for example. Preferably, the same vehicle function is controlled with different control commands depending on whether the position of the first or second key element has been detected.

In a further advantageous embodiment of the control system it is provided that the control device is configured to only control respective vehicle functions in dependence on respective detected positions of the second key element if at least one predetermined position of the first key element has been detected substantially simultaneously or in a timely fashion. The first key element can then also be referred to as the master key and the first key element as the slave key. This allows, for example, to provide convenient but controlled access for passengers at a transportation service provider, such as a taxi company. For example, in the case of an online booking, a digital key can be transmitted to the smartphone of the booking passenger, especially automatically in response to the booking. When approaching the vehicle, respective passenger doors can be opened automatically. As soon as the driver has left the vehicle with the master key, access with the passenger's slave key can be blocked. This means that the passenger can no longer enter the vehicle without authorization. Substantially simultaneously may involve a slight time offset. In particular, a threshold value of a period of time can also be specified for a timely fashion. If this threshold value is exceeded, the respective positions are no longer considered to be detected simultaneously. This threshold value can be configurable, for example, in particular by the owner of the master key. Each respective predetermined position can also relate to an area or zone relative to the motor vehicle, such as a motor vehicle interior. It is also possible to take into account a temporal progression of positions as a predetermined position, for example by a given movement pattern.

In a further advantageous embodiment of the control system, it is provided that the control system is configured so that the first parameter set and the second parameter set can be adjusted by means of the first key element and/or a central control element, in particular a control element of the motor vehicle. Such adjustability can also be referred to as configurability. Thus, an administration can be implemented with which, for example, the owner can manage respective rights and automatic controls. The first key element, for example configured as a smartphone, can thus have administrator rights. It may also be provided that, for example, the second parameter set will determine which parameters can be adjusted by the second key element or their owner. Thus, it can be managed which adjustments subordinate users are allowed to make themselves and which not. A configuration can be made, for example, by a control element of a motor vehicle infotainment system.

In a further advantageous embodiment of the control system it is provided that the control system is configured so that only the second parameter set or none of the parameter sets can be adjusted by means of the second key element. In particular, as already described, it may be limited which parameters can be adjusted. This can provide a subordinate key element which enables the user to use the vehicle conveniently without the possibility of letting the owner of the second key element configure the reaction of the control system to other key elements and/or in sensitive areas. Rights for adjustment using the second key element may be limited in this way.

In a further advantageous embodiment of the control system it is provided that the control system is configured so that by means of the first key element and/or a central control element, in particular a control element of the motor vehicle, it is possible to adjust which of the two sets of parameters can be adjusted, in particular which parts of the two sets of parameters can be adjusted. This makes it possible to manage the respective configurability, in particular centrally by means of a server as a central control element or centrally on the motor vehicle. For example, it can be adjusted whether the second key element can adjust or modify the first parameter set, the scope of vehicle functions and/or their control parameters.

The control system may be configured to control an access control system as a vehicle function. Such an access control system may be configured for a motor vehicle, wherein the motor vehicle has at least one access element, such as a door, a window and/or a boot lid, which is automatically moveable between a closed position and at least one open position. The access control system may have at least:
A movement device for moving the access element between its respective positions;
A detection device configured to detect at least one position of a portable key element relative to the motor vehicle by wireless transmission;
An environment sensing device configured to sense at least one environment parameter; and
A control device configured to control an adjustment movement of the access element in dependence on the detected position of the portable key element and in dependence on respective detected environment parameters.

This will improve automatic access control, since in addition to the position of the key element, environment conditions, especially the weather at the location of the vehicle, can also be taken into account. This can improve the comfort of the respective users. This is based on the realization that many owners find an automatic access control adjusted to the weather, in particular an automatic opening of the respective doors adjusted to the weather conditions, to be particularly convenient in different weather conditions. It is precisely these individual preferences that can be stored individually with regard to the first and second key elements.

Advantageously, the access control system can be configured in such a way that the adjustment movement of the respective access elements can be adjusted depending on the respective environment parameters, in particular by means of respective key elements. For example, an agile, young user can configure the access control system in such a way that in bad weather, for example in heavy rain, a vehicle door is automatically only opened briefly and/or with a small opening angle. As a result, the vehicle interior can be particularly well protected against adverse environmental conditions. For the agile user, the loss of comfort resulting from the need to get in quickly and/or to enter the vehicle through an access opening that is only slightly open can be acceptable and/or hardly perceptible. A less agile user may, for example, configure the access control system for bad weather conditions, especially in heavy rain, snow and/or ice, to automatically open a vehicle door for a long time and/or with a wide opening angle. For example, in these adverse environmental conditions, a less agile user may find it particularly difficult to get into his vehicle without falling. It is precisely then that comfortable boarding without rushing and with a generously released access opening is particularly important for the user's comfort. For this less agile user, this advantage and the resulting increased safety can more than compensate for a possible disadvantage caused by a potential unintentional damping of the interior of his vehicle.

A second aspect of the invention relates to a method of controlling at least one vehicle function of a motor vehicle. This method may comprise the step of detecting a position of a first portable key element by wireless transmission and/or detecting a position of a second portable key element by wireless transmission. Furthermore, the method can include the step of determining from which of the respective key elements the position has been detected and/or assigning respective detected positions to the respective key elements, in particular by means of a detection device. The method can also comprise control of respective vehicle functions depending on respective detected positions of the first key element and/or the second key element, in particular by means of a control device, wherein for substantially the same detected position of the first key element and the second key element in the case of the first key element respective vehicle functions are controlled with a first parameter set and in the case of the second key element respective vehicle functions are controlled with a second parameter set, wherein the first parameter set and the second parameter set differ from one another. Accordingly, respective vehicle functions can be controlled for different users according to their specific preferences.

The procedure according to the second aspect can be used with a control system according to the first aspect and/or control it. The characteristics and advantages resulting from the control system according to the first aspect can be found in the descriptions of the first aspect, whereby advantageous embodiments of the first aspect are to be regarded as advantageous embodiments of the second aspect and vice versa.

In a further advantageous embodiment of the method, it is provided that the two parameter sets each comprise a set of vehicle functions and the first parameter set differs from the second parameter set by at least one vehicle function which is controlled, and/or wherein the two parameter sets each comprise a set of control commands and the first parameter set differs from the second parameter set by at least one control command. Correspondingly, different vehicle functions and/or respective vehicle functions can be controlled differently when different users with different key elements approach the motor vehicle in the same way.

In a further advantageous embodiment of the control system it is provided that respective vehicle functions are controlled only in dependence on the detected position of the second key element in combination with the detected position of the first key element and respective vehicle functions are controlled in dependence on the detected position of the first key element without combination with the detected position of the second key element. Thus, a control can be implemented according to a master key and a slave key, which is especially advantageous for driving service providers.

In a further advantageous embodiment of the control system it is provided that at least one of the respective parameter sets is adjusted, whereby a respective adjustment of the first parameter set can be set exclusively by means of the first key element and/or a control element of the motor vehicle and optionally a respective adjustment of the second parameter set is set by means of the first key element, the second key element and/or a control element of the motor vehicle. This allows rights administration and/or configuration of personal preferences. The rights for modification can also be adjusted as a setting, for example by means of a control element and/or a respective one of the key elements, or via a central server.

Another aspect of the invention relates to a motor vehicle. This motor vehicle may be configured to cooperate with and/or be part of the control system according to the first aspect of the invention and/or be controlled by the method according to the second aspect. Alternatively or additionally, the motor vehicle may also be configured, in particular its respective vehicle functions, to be controlled by the control system according to the first aspect. The features and advantages resulting from the control system according to the first aspect and the method according to the second aspect are to be taken from the descriptions of the first and second aspect respectively, whereby advantageous embodiments of the first and second aspect respectively are to be regarded as advantageous embodiments of the third aspect and vice versa.

In particular, the motor vehicle may include a detection device which is configured to detect by wireless transmission at least one position of respective portable key elements relative to the motor vehicle and which is configured to determine by wireless transmission of which of the respective portable key elements the position has been detected. The motor vehicle can comprise a control device which is configured to control respective vehicle functions in dependence on the respective detected position of a first key element and/or a second key element, wherein the control device is configured to control respective vehicle functions for substantially equal positions of the first and second key elements with a first parameter set in case of the first key element and to control respective vehicle functions with a second parameter set in case of the second key element, wherein the first parameter set and the second parameter set differ from one another.

### BRIEF DESCRIPTION OF THE DRAWINGS

FIG. 1 illustrates in a schematic view a control system for a motor vehicle.

### DETAILED DESCRIPTION OF EMBODIMENTS

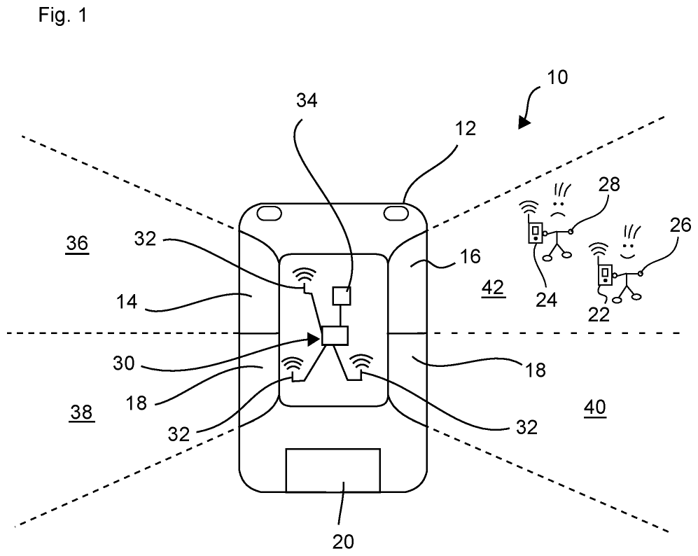

FIG. 1 shows in a schematic view a control system 10 for a motor vehicle 12. The motor vehicle 12 comprises a driver's door 14, a passenger door 16, two rear side passenger doors 18 and a boot lid 20 as access elements. The control system 10 also comprises a first key element 22 and a second key element 24, which are each configured as a smartphone. The first key element 22 is carried by a first person 26 and the second key element 24 by a second person 28.

The control system 10 also comprises a detection device 30, which in this case is part of the motor vehicle 12. The detection device 30 is configured to detect at least one position of the respective portable key elements 22, 24 relative to the motor vehicle 12 by wireless transmission. In addition, the detection device 30 is configured to determine, also by wireless transmission, of which of the respective portable key elements 22, 24 the position has been detected. An assigned position of the respective key elements 22, 24 is thus detected. For this purpose, the detection device 30 has, for example, three antennas 32 by means of which the position of the respective key elements 22, 24 can be determined by means of wireless transmission triangulation.

The control system 10 further comprises a control device 34, which is configured to control respective vehicle functions of the motor vehicle 12 as a function of respective detected positions of the first and/or second key element 22, 24. The control device 34 is presently also arranged in the motor vehicle 12. An exemplary vehicle function is an automatic opening of the respective access elements 14, 16, 18 and 20 of the motor vehicle 12. This enables automatic access to the motor vehicle 12 when the respective person 26, 28 approaches.

The control device 34 is configured to control respective vehicle functions for substantially equal positions of the first and second key elements 22, 24 with a first parameter set in case of the first key element 22 and respective vehicle functions with a second parameter set in case of the second key element 24, wherein the first parameter set and the second parameter set differ from each other. This makes it possible to configure an automatic reaction of the motor vehicle 12 to an approach of different persons or different key elements differently according to respective user preferences.

The essentially same position can be specified with respective tolerance deviation and/or respective detection ranges. These tolerance deviations and/or detection ranges can be specific to the vehicle function. FIG. 1 shows four detection areas 36, 38, 40 and 42, which are each assigned to one access element 14, 16 and 18, with dashed lines. A detection of a key element in one of these areas is defined as the same position for the automatic control of the access elements 14, 16 and 18, independent of an actual spatial position.

These detection zones 36, 38, 40 and 42 are exclusively intended for the automatic control of these access elements 14, 16 and 18. If a position of a key element in one of these detection areas 36, 38, 40 and 42 is detected and optionally additionally a movement towards the respective assigned access element 14, 16 and 18 is detected, the corresponding access element is automatically opened by the control device 34 in order to enable convenient entry into motor vehicle 12.

In the present case, the person in question is, for example, an elderly person who prefers a particularly wide opening angle of the respective access elements when entering the vehicle. Accordingly, when the first key element 22 is detected, the corresponding access element can be opened wide, in accordance with this user preference. The person 28, for example, is a younger person who prefers a smaller opening angle of the respective access elements so that they can be closed quickly and easily after entering the vehicle. This user preference can also be taken into account in the automatic control by the control device 34.

In addition, control system 10 can provide a hierarchical structure for vehicle function control. For example, person 26 is the owner of motor vehicle 12, whereas person 28 is merely a driver hired for a short time to cover a longer distance. For this purpose, person 26 has assigned person 28 to drive the car using their smartphone 22 or key element 22. During the hiring, a digital key was transmitted from the smartphone 22 to the smartphone 24 or the second key element 24 of person 28, whereby the smartphone 24 was configured as the second key element 24. The parameter sets of the control device 34 are configured in such a way that respective vehicle functions are only controlled upon detection of the key element 24 if the first key element 22 has also been detected in a predetermined position relative to the vehicle 12, such as within a minimum distance. This prevents unauthorized access of person 28 to motor vehicle 12 in the absence of the owner 26.

In the example shown, both person 26 and person 28 with their assigned key elements 22, 24 are in the same area 42, which is assigned to the passenger door 16. The key elements 22, 24 are therefore in essentially the same position with respect to the vehicle function of an access control system. By detecting the first key element 22 in this detection area 42 and based on the hiring of the driver 28, the control device 34 determines that the person 26 wants to enter as a passenger and accordingly opens the passenger door 16 automatically. Since person 28 was classified system-internal as a driver, such control of the vehicle functions would not further increase comfort or be meaningful despite the presence of person 28 with the second key element 20 24 in the same detection area 42. By hiring person 28 as driver, however, a corresponding assigned parameter set can be configured so that when the second key element 24 is detected in the vicinity of motor vehicle 12, i.e. also in detection range 42, driver's door 14 is categorically always opened automatically. In addition, starting the engine can be enabled as an additional vehicle function so that the driver or person 28 can start the vehicle immediately after entering motor vehicle 12.

In addition, by detecting the first key element 22, it is also possible, for example, to start and set an air conditioning system in motor vehicle 12 according to the user preferences of the person 26. Due to the hierarchical structure, the user preferences of person 26 can take precedence over the user preferences of person 28 regarding the air conditioning system.

The person 26 can preferably configure their user preferences directly with the first key element 22. This configuration allows the respective parameter sets to be adjusted so that a corresponding automatic reaction of the motor vehicle 12 to a position determination of the first key element 22 can be set. Preferably, the first key element 22 can be used to configure the parameter sets assigned to both the first key element 22 and the second key element 24. The second key element 24, on the other hand, can preferably only be used to adjust the parameter sets assigned to the second key element 24. Preferably, the configurability of the parameter set assigned to the second key element 24 is restricted for the second key element 24 and/or respective restrictions can be configured by the first key element 22, so that the driver who is only temporarily hired can only store desired preferences, such as adjusting the driver seat to his needs.

The control system 10 increases the convenience of using a motor vehicle 12 for respective users. In particular, the control system 10 is particularly suitable for improving the comfort of use of motor vehicle 12 by different users.

### REFERENCE SIGNS

10 control system
12 motor vehicle
14 driver's door
16 passenger door
18 rear passenger doors
20 boot lid
22 first key element
24 second key element
26 first person
28 second person
30 detection device
32 antenna
34 control device
36 detection area
38 detection area
40 detection area
42 detection area

1. A control system for a motor vehicle, the control system comprising:
a first portable key element;
a second portable key element;
a detection device configured to detect, by wireless transmission, at least one position of the first portable key element and/or the second portable key element relative to the motor vehicle and configured to determine, by wireless transmission, from which of the first portable key element and/or the second portable key element the detected position has been detected; and
a control device configured to control respective vehicle functions in dependence on the detected position of the first portable key element and/or the second portable key element,
wherein the control device is configured to control the respective vehicle functions for substantially equal positions of the first portable key element and second portable key element with a first parameter set in case of the first portable key element,
wherein the control device is configured to control the respective vehicle functions with a second parameter set in case of the second portable key element, and
wherein the first parameter set and the second parameter set differ from each other.

2. The control system according to claim 1, wherein the respective vehicle functions are unlocking and/or opening respective access elements, activating and/or adjusting a ventilation system, adjusting respective vehicle seats, activating an ignition and/or starting an engine, and/or authorizing a use of vehicle functions.

3. The control system according to claim 1, wherein the first parameter set comprises a first set of vehicle functions, wherein the second parameter set comprises a second set of vehicle functions, and wherein the first set of vehicle functions and the second set of vehicle functions differ from each other by at least one of the respective vehicle functions of the motor vehicle.

4. The control system according to claim 1, wherein the first parameter set comprises a first set of control commands for the respective vehicle functions, wherein the second parameter set comprises a second set of control commands for the respective vehicle functions, and wherein the first set of control commands and the second set of control commands differ from each other in at least one control command.

5. The control system according to claim 1, wherein the control device is configured to only control the respective vehicle functions in dependence on the detected position of the second portable key element when at least one predetermined position of the first portable key element has been detected substantially simultaneously or in a timely fashion.

6. The control system according to claim 1, wherein the control system is configured so that the first parameter set and the second parameter set is adjustable by the first portable key element and/or a central control element.

7. The control system according to claim 1, wherein the control system is configured so that only the second parameter set or no parameter set are adjustable by the second portable key element.

8. The control system according to claim 1, wherein the control system is configured so that it is adjustable by means of the first portable key element and/or by means of a central control element, which one of the first parameter set and the second parameter set is adjustable.

9. A method for controlling at least one vehicle function of a motor vehicle, comprising:
detecting a position of a first portable key element and/or a second portable key element by wireless transmission;
determining from which of the first portable key element and/or the second portable key element the detected position was detected and/or assigning the detected positions to the first portable key element and/or the second portable key element; and
controlling respective vehicle functions in dependence on the detected positions of the first portable key element and/or the second portable key element,
wherein, when the detected positions of the first portable key element and the second portable key element are equal, the respective vehicle functions are controlled with a first parameter set in case of the first portable key element and the respective vehicle functions are controlled with a second parameter set in case of the second portable key element, and
wherein the first parameter set and the second parameter set differ from each other.

10. The method according to claim 9, wherein the first parameter set and the second parameter set each comprises a set of vehicle functions, wherein the first parameter set differs from the second parameter set by at least one vehicle function which is controlled, and/or wherein the first parameter set and the second parameter set each comprises a set of control commands, wherein the first parameter set differs from the second parameter set by at least one control command.

11. The method according to claim 9, wherein the respective vehicle functions are only controlled in dependence on the detected position of the second portable key element in combination with the detected position of the first portable key element and the respective vehicle functions are controlled in dependence on the detected position of the first portable key element without combination with the detected position of the second portable key element.

12. The method according to claim 9, wherein at least one of the first parameter set and the second parameter set is adjusted, wherein a respective adjustment of the first parameter set can be adjusted exclusively by means of the first portable key element and/or a control element of the motor vehicle and/or wherein a respective adjustment of the second parameter set is set by means of the first portable key element, the second portable key element and/or a control element of the motor vehicle.

13. The control system according to claim 2, wherein the ventilation system is an air conditioning system the vehicle function is a driving function accessed by unlocking an immobilizer.

14. The control system according to claim 2, wherein the vehicle function is a driving function accessed by unlocking an immobilizer.

15. The control system according to claim 8, wherein the control system is configured so that it is adjustable by the first portable key element and/or by a central control element, which part of the first parameter set and the second parameter set are adjustable.
